(19) United States
(12) Patent Application Publication
(10) Pub. No.: US 2023/0342962 A1
(43) Pub. Date: Oct. 26, 2023

(54) SPECIAL DANGEROUS TERRAIN RECOGNITION METHOD AND APPARATUS FOR FOREST FIRE

(71) Applicants: TSINGHUA UNIVERSITY, Beijing (CN); BEIJING GLOBAL SAFETY TECHNOLOGY CO., LTD., Beijing (CN)

(72) Inventors: Tao CHEN, Beijing (CN); Guofeng SU, Beijing (CN); Zhanhui SUN, Beijing (CN); Lifan ZHANG, Beijing (CN); Zhili FENG, Beijing (CN); Xin LIU, Beijing (CN); Zhipeng LI, Beijing (CN); Zheng LI, Beijing (CN)

(21) Appl. No.: 18/254,564

(22) PCT Filed: Aug. 18, 2021
(86) PCT No.: PCT/CN2021/113333

§ 371 Date: May 25, 2023

(30) Foreign Application Priority Data
Nov. 27, 2020 (CN) 202011360129.5

(51) Int. Cl. G06T 7/564; G06T 7/13; G06T 7/00; G06T 7/73

(52) U.S. Cl. CPC G06T 7/564; G06T 7/13; G06T 7/0002; G06T 7/73; G06T 2207/30181

(57) ABSTRACT

A method for identifying a forest fire special dangerous terrain includes: obtaining raw digital elevation model (DEM) data of a valley and inverse raw DEM data of a ridge in a target area; extracting an elevation difference and a first derivative of a contour line within a preset range of the target area according to the raw DEM data and/or the inverse raw DEM data; calculating a danger level value of the target area based on the elevation difference and the first derivative of the contour line, in which, when the danger level value is greater than a preset threshold, it is determined that the target area is a dangerous terrain of a valley between two mountains or a narrow ridge.

### CROSS-REFERENCE TO RELATED APPLICATIONS

The application is a U.S. national stage entry under 35 U.S.C. § 371 of International Application PCT/CN2021/113333, filed Aug. 18, 2021, which claims priority to Chinese Patent Application No. 202011360129.5, filed Nov. 27, 2020, the entire disclosures of which are incorporated by reference herein.

### TECHNICAL FIELD

The present disclosure generally relates to a technical field of digital terrain analysis, and more particularly to a method and an apparatus for identifying a forest fire special dangerous terrain.

### BACKGROUND

In the related art, the technology of digital terrain analysis is used to study the terrain and the landform, so as to comprehensively analyze the threat of the terrain to the personal safety of forest fire firefighters, and determine the dangerous terrain. Thus, after a forest fire occurs, the firefighters can avoid the dangerous terrain, thus improving the safety coefficient and ensuring the personal safety.

However, a mountain-shaped landform itself is not dangerous. Only after the forest fire occurs, when the firefighters go deep into the forest to fight the fire, the personal safety will be threatened due to the impact of the special terrain on the behavior of the forest fire. This is interspersed with the content of thermodynamics, such that there is very little geographical analysis research on forest fire scenarios in the related art, a reliability and an accuracy of a dangerous terrain identification are low, and the personal safety of firefighters cannot be effectively guaranteed.

### SUMMARY

Embodiments of a first aspect of the present disclosure provide a method for identifying a forest fire special dangerous terrain, including steps: obtaining raw digital elevation model (DEM) data of a valley and inverse raw DEM data of a ridge in a target area; extracting an elevation difference and a first derivative of a contour line within a preset range of the target area according to the raw DEM data and/or the inverse raw DEM data; calculating a danger level value of the target area based on the elevation difference and the first derivative of the contour line, in which, when the danger level value is greater than a preset threshold, it is determined that the target area is a dangerous terrain of a valley between two mountains or a narrow ridge. Extracting the elevation difference and the first derivative of the contour line within the preset range of the target area according to the raw DEM data and/or the inverse raw DEM data includes: reading the raw DEM data and/or the inverse raw DEM data, and establishing a rectangular plane coordinate system to determine a position of each grid; extracting a square calculation region from the raw DEM data and/or the inverse raw DEM data, and extracting a plurality of elevation data from any grid to obtain the elevation difference, based on the preset range; performing linear fitting on the plurality of elevation data, extracting a plurality of contour features, and calculating a first derivative of a section curve according to the plurality of contour features.

The danger level value of each grid is calculated by a formula:

$${D}_{norm} = \frac{D - {D}_{min}}{{D}_{max} - {D}_{min}} \cdot 1000 ,$$

where Dₙₒᵣₘ is a dimensionless danger level, D is an original danger level value of the grid, Dₘᵢₙ is a minimum danger level value in all the grids, and Dₘₐₓ is a maximum danger level value in all the grids.

Alternatively, in one embodiment of the present disclosure, obtaining the raw DEM data of the valley and the inverse raw DEM data of the ridge in the target area further includes: performing searching based on a preset radius to obtain the raw DEM data; and/or performing inverse terrain processing on the raw DEM data to obtain the inverse raw DEM data.

Embodiments of a second aspect of the present disclosure provide an electronic device, including: at least one processor; and a memory communicatively connected with the at least one processor; in which the memory stores instructions executable by the at least one processor, and the instructions are configured to execute the method for identifying the forest fire special dangerous terrain according to the above embodiments.

Embodiments of a third aspect of the present disclosure provide a non-transitory computer-readable storage medium. The non-transitory computer-readable storage medium stores computer instructions, and the computer instructions are configured to cause the computer to execute the method for identifying the forest fire special dangerous terrain according to the above embodiments.

Additional aspects and advantages of the disclosure will be given in part in the following description, will become apparent in part from the following description, or may be learned by the practice of the disclosure.

### BRIEF DESCRIPTION OF THE DRAWINGS

The above and/or additional aspects and advantages of the present disclosure will become apparent and more readily appreciated from the following descriptions made with reference to the drawings, in which:

FIG. 1 is a flow chart of a method for identifying a forest fire special dangerous terrain provided according to an embodiment of the present disclosure;

FIG. 2 is a flow chart of a method for identifying a forest fire special dangerous terrain according to a specific embodiment of the present disclosure;

FIG. 3 is a schematic diagram of sectional elevation data extraction according to an embodiment of the present disclosure;

FIG. 4 is a schematic diagram of the results of sectional contour fitting according to an embodiment of the present disclosure;

FIG. 5 is a schematic diagram of the valley depth H (90° section) according to an embodiment of the present disclosure;

FIG. 6 is a schematic diagram of a valley line analyzed in the related art;

FIG. 7 is a schematic diagram of comparison before and after the identification of a valley between two mountains according to an embodiment of the present disclosure;

FIG. 8 is a schematic diagram of a ridge according to an embodiment of the present disclosure;

FIG. 9 is a schematic diagram of a ridge analyzed in the related art;

FIG. 10 is a schematic diagram of the effect of narrow ridge identification according to an embodiment of the present disclosure;

FIG. 11 is a schematic block diagram of an apparatus for identifying a forest fire special dangerous terrain provided according to an embodiment of the present disclosure;

FIG. 12 is a schematic block diagram of an electronic device provided according to an embodiment of the present disclosure.

### DETAILED DESCRIPTION

Embodiments of the present disclosure are described in detail below, examples of which are shown in the drawings, in which the same or similar reference numerals denote the same or similar elements or elements having the same or similar functions throughout the description. The embodiments described below by referring to the drawings are exemplary and intended to explain the present disclosure, and should not be construed to limit the present disclosure.

The first objective of the present disclosure is to propose a method for identifying a forest fire special dangerous terrain, which improves a reliability and an accuracy of a dangerous terrain identification, so that firefighters can effectively avoid the dangerous terrain, the safety coefficient is improved, and the personal safety is ensured.

The second objective of the present disclosure is to propose an apparatus for identifying a forest fire special dangerous terrain.

The third objective of the present disclosure is to propose an electronic device.

The fourth objective of the present disclosure is to propose a non-transitory computer-readable storage medium.

A method and an apparatus for identifying a forest fire special dangerous terrain according to embodiments of the present disclosure will be described below with reference to the drawings.

Firstly, the method for identifying the forest fire special dangerous terrain according to the embodiments of the present disclosure will be described with reference to the drawings.

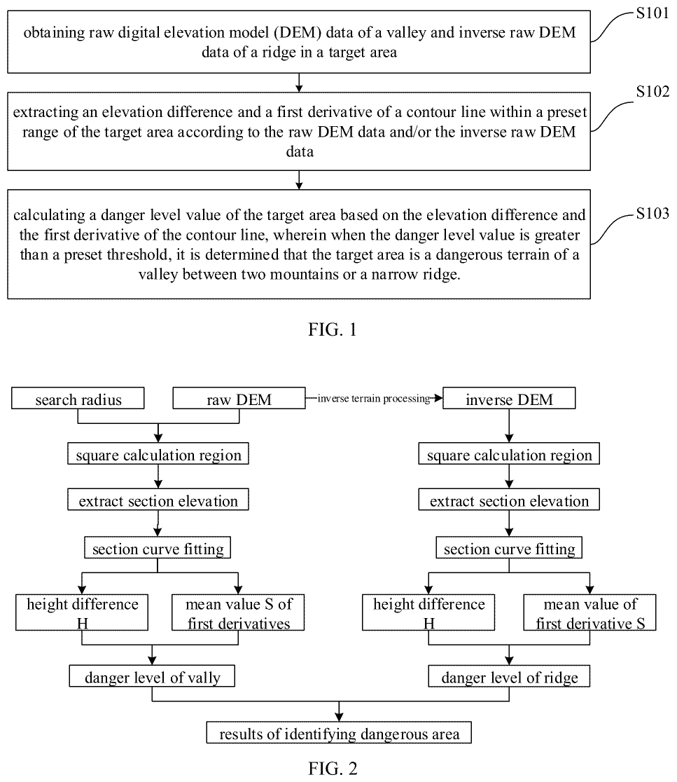

Specifically, FIG. 1 is a schematic flowchart of a method for identifying a forest fire special dangerous terrain provided according to embodiments of the present disclosure.

As shown in FIG. 1, the method for identifying the forest fire special dangerous terrain includes steps as follows:

In step S101, raw digital elevation model (DEM) data of a valley and inverse raw DEM data of a ridge in a target area are obtained.

It can be understood that, in the embodiments of the present disclosure, firstly, an inverse terrain elevation change map completely opposite to an original terrain is calculated based on the raw terrain elevation data. The raw DEM is configured to identify a dangerous terrain of a valley between two mountains, the inverse DEM is configured to identify a narrow terrain, and examples are given below.

Alternatively, in one embodiment of the present disclosure, obtaining the raw DEM data of the valley and the inverse raw DEM data of the ridge in the target area further includes: performing searching based on a preset radius to obtain the raw DEM data; and/or performing inverse terrain processing on the raw DEM data to obtain the inverse raw DEM data.

Those skilled in the art should understand that the essential reason why the valley between two mountains is likely to cause casualties is that the two mountains are at a short distance and are steep; and under the influence of fire, the wind direction in the valley is prone to sudden change, which makes the disaster relief personnel unable to judge the trend of fire spread. However, the identification of the narrow ridge is similar to the identification of a valley between two mountains. After the raw DEM is subjected to inverse terrain processing, the identification of the narrow ridge in the original terrain can be converted to the identification of a valley between two mountains in the inverse terrain. Therefore, for the identification of the narrow ridge, it is only necessary to bring the inverse terrain into the model for calculation. Thus, for the convenience of description, in the subsequent embodiments, the dangerous terrain with a valley between two mountains is used as a specific example for illustration.

In step S102, an elevation difference and a first derivative of a contour line within a preset range of the target area are extracted according to the raw DEM data and/or the inverse raw DEM data.

As a possible implementation, in the embodiments of the present disclosure, it is possible to use the elevation difference and the first derivative of the valley contour line within the certain range on both sides of the valley to measure whether the valley is sandwiched by steep and close-distance peaks, and use the danger level value to quantify it. The steeper and narrower the valley, the higher the danger level value.

Alternatively, in one embodiment of the present disclosure, extracting the elevation difference and the first derivative of the contour line within the preset range of the target area according to the raw DEM data and/or the inverse raw DEM data comprises: reading the raw DEM data and/or the inverse raw DEM data, and establishing a rectangular plane coordinate system to determine a position of each grid; extracting a square calculation region from the raw DEM data and/or the inverse raw DEM data, and extracting a plurality of elevation data from any grid to obtain the elevation difference, based on the preset range; performing linear fitting on the plurality of elevation data, extracting a plurality of contour features, and calculating a first derivative of a section curve according to the plurality of contour features.

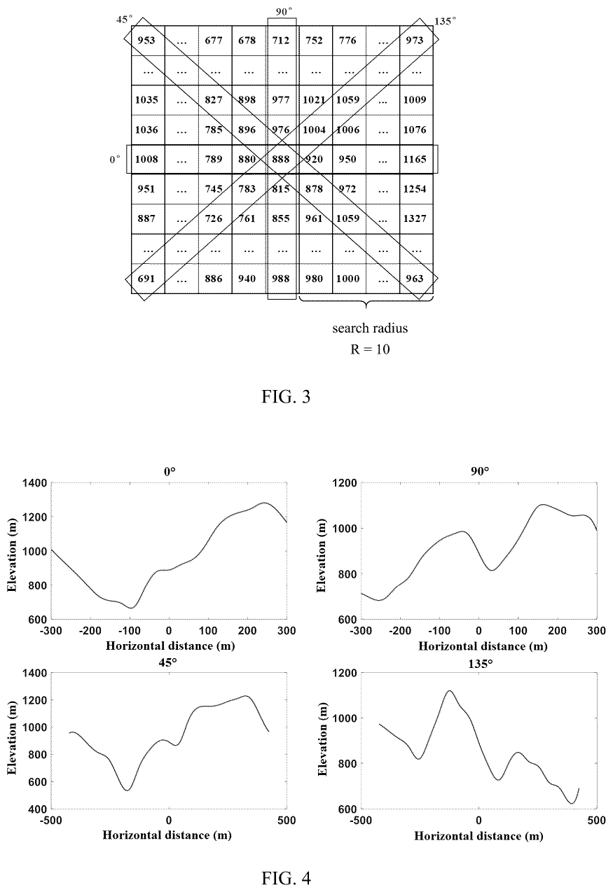

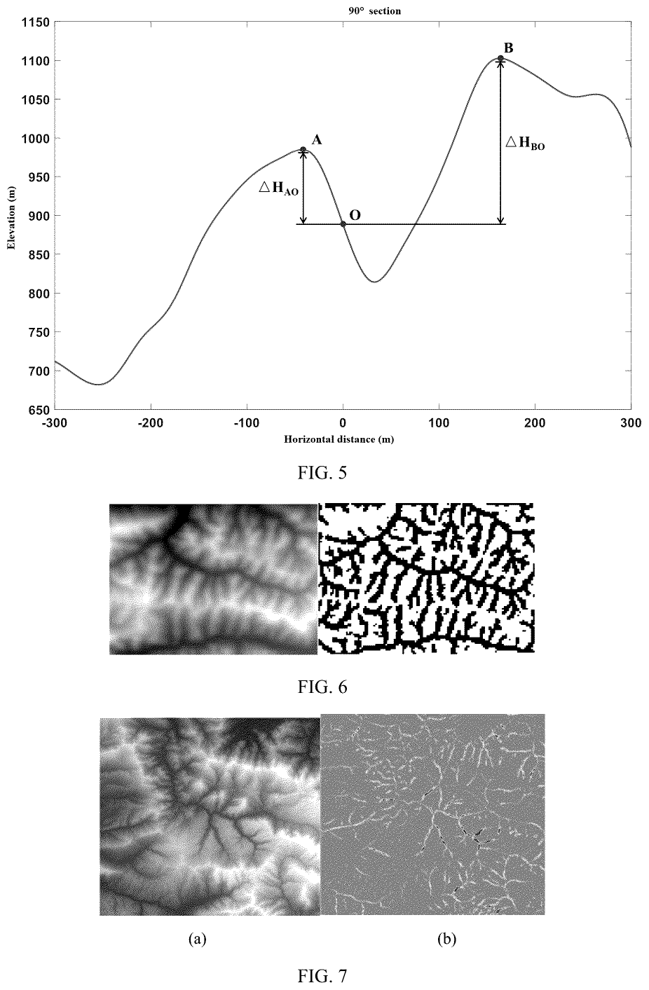

In the actual execution process, as shown in FIG. 2, the embodiments of the present disclosure includes as follows:
Step S1: the DEM data is read, a rectangular plane coordinate system is established, and coordinates (x, y) are used to represent the position of each grid in the DEM.
Step S2: a grid in the DEM is selected as the grid to be calculated, and a grid (a, b) is taken as an example to illustrate the calculation steps in the embodiments of the present disclosure.
Step S3: an appropriate search radius R is selected, where R represents the number of grids searched around. Taking the grid (a, b) as the center, a square calculation region is extracted with a side length of 2R+1 from the DEM. Calculations in the subsequent steps are performed based on the data in this region, e.g., taking R=10 as an example.
Step S4: in the square calculation region, four pieces of elevation data are extracted from the grid (a, b) and at angles of 0°, 45°, 90° and 135° to a horizontal direction, as shown in FIG. 3, to store the elevation data of the grid (a, b) on four sections in an actual terrain.
Step S5: a cubic spline function with one-dimensional natural boundary conditions is selected to fit the four pieces of elevation data extracted in the previous step respectively, obtaining the function expressions of the four sections of the grid (a, b). The function image is drawn to intuitively reflect the contours of the four sections, in which x=0 corresponds to the grid (a, b), as shown in FIG. 4.
Step S6: the point corresponding to x=0 in the function is the grid (a, b), denoted as point O. The maximum values on the left and right sides of point O are found respectively, denoted as A, and B. The minimum value of them is taken as the valley depth H of the grid (a, b). If the minimum value is negative, it is set to 0. The calculation process is illustrated by taking the function corresponding to the 90° section as an example. As shown in FIG. 5, the section H=ΔH_{AO}.
Step S7: the mean value S of the first derivatives of the function between the AB section is calculated, which is configured to reflect the steepness at the point O. Since the first derivative of the function is negative when the left side of the O point is on an uphill slope, the derivative of the AO section as calculated needs to take the opposite number, in which the calculation formula is shown in formula 1:

$$S = \frac{- {\int }_{{x}_{A}}^{{x}_{O}} {f}^{′} ( x ) dx + {\int }_{{x}_{O}}^{{x}_{B}} {f}^{′} ( x ) dx}{{x}_{B} - {x}_{A}} \qquad ( formula 1 )$$

In step S103, a danger level value of the target area is calculated based on the elevation difference and the first derivative of the contour line, in which when the danger level value is greater than a preset threshold, it is determined that the target area is a dangerous terrain of a valley between two mountains or a narrow ridge.

Alternatively, in one embodiment of the present disclosure, the danger level value of each grid is calculated by a formula:

$${D}_{norm} = \frac{D - {D}_{min}}{{D}_{max} - {D}_{min}} \cdot 1000 ,$$

where Dₙₒᵣₘ is a dimensionless danger level, D is an original danger level value of a grid, Dₘᵢₙ is a minimum danger level value in all the grids, and Dₘₐₓ is a maximum danger level value in all the grids.

Based on the description of other related embodiments, it can be understood that the embodiments of the present disclosure also include as follows:
Step S8: according to the valley depth H of the four sections and the mean value S of the first derivatives, the danger levels D of the four sections of the grid (a, b) are calculated respectively, in which the calculation formula is shown in formula 2:

D=H·S (formula 2).

After the danger level values of the four sections are calculated by formula 2, the maximum value of them is taken as the danger level value of the grid (a, b).
Step S9: steps S4 to S8 are repeated to calculate the danger level values of all the grids in the area.
Step S10: the danger level values of all the grids in the area are nondimensionalized, and scaled to a range [0, 1000], in which the calculation formula is shown in formula 3:

$${D}_{norm} = \frac{D - {D}_{min}}{{D}_{max} - {D}_{min}} \cdot 1000 , \qquad ( formula 3 )$$

In the formula, Dₙₒᵣₘ represents a dimensionless danger level, D represents an original danger level value of a grid, Dₘᵢₙ represents a minimum danger level value in all the grids, and Dₘₐₓ represents a maximum danger level value in all the grids.

To sum up, in order to implement the effect of automatically identifying the forest fire special dangerous terrains in the embodiments of the present disclosure, firstly, the dangerous terrains are defined as two dangerous terrains: a valley between two mountains and a narrow ridge. Secondly, the grid analysis method is used as a basic method, in combination with DEM (Digital Elevation Model), and the morphological characteristics of the valley are comprehensively analyzed by extracting the valley cross-section contour, contour curve fitting, function extreme value analysis, and first derivative analysis, reaching the effect of automatically identifying the above-mentioned dangerous terrains.

Specifically, in the embodiments of the present disclosure, the high-incidence areas of casualties are analyzed and studied through the review of a large number of historical forest fire fighting cases and related experience learning, and the principle of the danger of forest fire in the corresponding terrain is deeply analyzed from the perspective of heat radiation and heat propagation, so as to comprehensively analyze the terrain that affects personal safety, which is different from the application of the traditional digital terrain analysis in geomorphology.

(1) A Valley Between Two Mountains

The special terrain of a valley between two mountains is rarely mentioned in occasions other than the forest fire fighting. The main danger thereof lies in the fact that the wind speed will increase when the wind crosses between the two mountains, and the change in the wind speed on both sides will easily cause turbulent flow. Secondly, a large amount of combustible materials are usually accumulated in the valley, and the water loss on hillsides on both sides under the influence of slope is more likely to cause danger of uphill fires. The uphill fires spread extremely fast, and when the hillside on one side is on fire, it will burn the opposite hillside, making the opposite hillside more flammable. Under such conditions, phenomena such as “deflagration”, “flashover”, and “flying fire” are very prone to occur in the environment of the valley between two mountains, and the escape route of the personnel under special circumstances is single and prone to blockage, which is a very dangerous forest fire fighting section. Therefore, identifying a valley between two mountains requires not only identifying whether there are ridges on both sides of the valley, but also judging whether the distance between the ridges on both sides is close enough and steep enough.

At present, there are few technologies for identifying a terrain of “a valley between two mountains”. Most terrain identification methods mainly focus on valley lines and ridge lines, and extracts all ridges and valleys from the DEM as accurately as possible, as shown in FIG. 6.

It can be concluded from FIG. 6 that the results obtained by the terrain extraction method in the related art are basically similar to the actual terrain, and the valley lines in the area can be identified more accurately. However, in the process of the forest fire fighting, not all valleys are dangerous. There are many valley lines obtained by traditional terrain identification methods, and most of the identified valleys are not dangerous in the actual disaster relief process. Therefore, only relying on traditional terrain identification methods cannot provide the disaster relief personnel with intuitive and accurate early warning information of dangerous areas.

When the hillsides on both sides of the valley are steeper in slope and are at a closer distance, the danger of the forest fires is also greater. Therefore, in the embodiments of the present disclosure, a large number of review studies are carried out on historical forest fire fighting cases, and a technical solution is proposed for automatically identifying dangerous areas such as “a valley between two mountains”, which can accurately calculate the danger level of each area by using regional DEM data, so as to screen out the valleys with higher danger levels.

According to the search radius, the square calculation region centered on the grid to be calculated is obtained from the DEM, the sectional elevation data in four directions of the grid to be calculated is extracted in the area, and the danger level value of the grid to be calculated is obtained through mathematical methods such as curve fitting, function extreme value analysis and function first derivative analysis. The danger level values are expressed in different colors, which intuitively reflect the danger level of the valley between two mountains in the area. The identification effect of the method is shown in FIG. 7-(b), where the darker areas represent places with a higher danger level, and the lighter areas represent relatively safe places. By comparing FIG. 7-(a) and FIG. 7-(b), it can be seen that the narrow valleys with steep hillsides on both sides in the DEM are identified as a dangerous area with a heavier color, which meets the judgment requirements of the valley between two mountains.

In addition, it can be seen from FIG. 7-(a) that the valley area is relatively messy, in which some valleys are relatively wide, and some valleys have relatively gentle hillsides on both sides of the valleys. It is not easy for a mountain to catch fire and then roast the adjacent hillside, and such valley sections do not belong to the dangerous valley section of “a valley between two mountains”. The heavily colored area in FIG. 7-(b) is the dangerous valley section automatically extracted after analysis. Compared with FIG. 7-(a), the wide valleys and the valleys with gentle hillsides on both sides have been basically excluded.

(2) Narrow Ridge

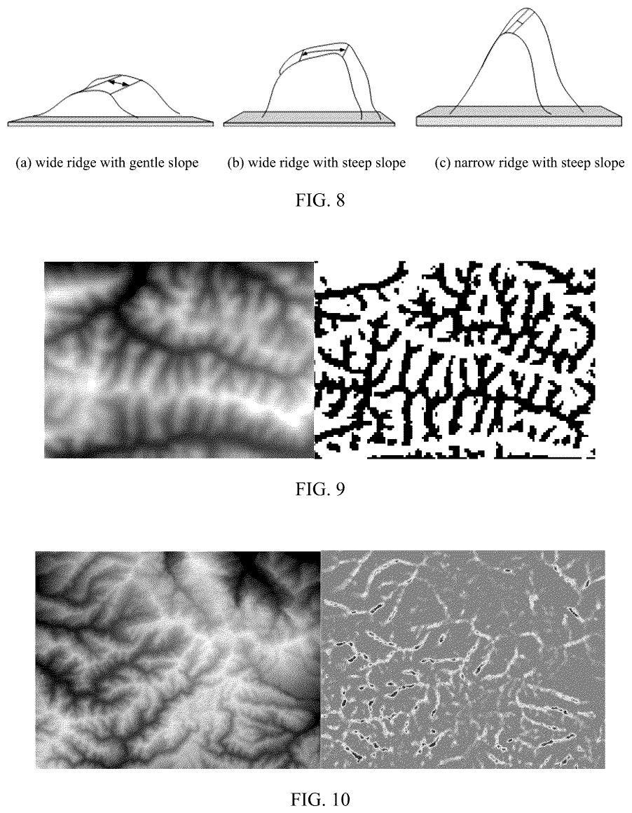

There are two main dangers of the narrow ridge: the first is that the narrow ridge is the convex part of the mountain range, which is prone to heat conduction and heat radiation. Heat accumulation leads to high temperature, and changes in wind direction at the ridges lead to the forest fires that change rapidly and are unpredictable. Casualties are extremely prone to occur here. The second is because of people crossing the ridge and the characteristics of the spread of forest fires. When the slope of the mountain is relatively gentle, even if the width of the ridge is relatively narrow, the impact of the slope on the spread of forest fires is small. Such ridges are also less threatening to people. As shown in FIG. 8, the two ridges shown in FIG. 8-(a) and FIG. 8-(b) are ridges with lower danger level values, and the specific reasons can be seen in the above analysis.

Common ridge analysis methods include methods based on the Earth's surface morphology, methods based on image processing, methods based on triangular grids and methods based on water flow analysis. Although the above methods can analyze the ridgeline, they cannot be directly used in forest fire fighting. For example, when the width of the ridge is large, the wind will cross the ridge relatively smoothly, and the heat will be taken away to a certain extent, and the wind direction is relatively fixed. Such a wide ridge will not cause casualties. When the slope of the mountain is small, the mountain has little effect on the wind speed and the wind direction, the possibility of eddy currents is small, and it is relatively easy for rescuers to climb over the ridge. Such ridges do not belong to the dangerous terrain in forest fire fighting. Therefore, some of the ridges analyzed by the above methods are ridge lines without a width, and some ridges analyzed have a width, but the final result is the complete set of ridges, as shown in FIG. 9.

Therefore, in the embodiments of the present disclosure, a narrow ridge in the specific scene is identified, the elevation difference and the slope change on both sides of the identified ridge are analyzed, and the dangerous narrow ridge that is likely to cause casualties during the forest fire fighting is screened out. The basic principle of the method is similar to that of the valley extraction, except that the raw DEM needs to be subjected to inverse terrain processing before calculation, and its identification effect is shown in FIG. 10.

According to the method for identifying the forest fire special dangerous terrain in the embodiments of the present disclosure, the danger level value of the target area is calculated from the elevation difference and the first derivative of the contour line within a certain range of the target area, so as to identify the dangerous terrain of the valley between two mountains or the narrow ridge according to the danger level value. It is possible to achieve the purpose of identifying the dangerous terrain accurately, which improves the reliability and the accuracy of the dangerous terrain identification. Thus, the firefighters can effectively avoid the dangerous terrain, such that the safety coefficient is improved and the personal safety is ensured.

Secondly, the apparatus for identifying the forest fire special dangerous terrain according to the embodiments of the present disclosure will be described with reference to the drawings.

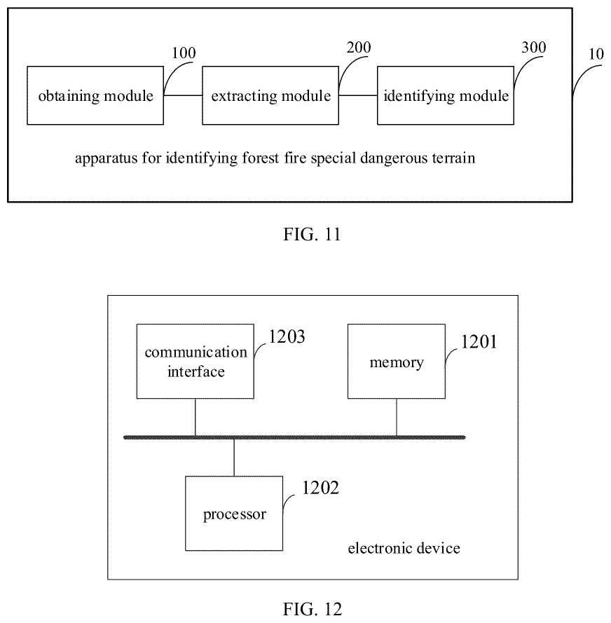

FIG. 11 is a schematic block diagram of the apparatus for identifying the forest fire special dangerous terrain according to the embodiments of the present disclosure.

As shown in FIG. 11, the apparatus 10 for identifying the forest fire special dangerous terrain includes: an obtaining module 100, an extracting module 200 and an identifying module 300.

Specifically, the obtaining module 100 is configured to obtain raw DEM data of a valley and inverse raw DEM data of a ridge in a target area.

The extracting module 200 is configured to extract an elevation difference and a first derivative of a contour line within a preset range of the target area according to the raw DEM data and/or the inverse raw DEM data.

The identifying module 300 is configured to calculate a danger level value of the target area based on the elevation difference and the first derivative of the contour line, in which when the danger level value is greater than a preset threshold, it is determined that the target area is a dangerous terrain of a valley between two mountains or a narrow ridge.

Alternatively, in one embodiment of the present disclosure, the obtaining module 100 is further configured to perform searching based on a preset radius to obtain the raw DEM data; and/or perform inverse terrain processing on the raw DEM data to obtain the inverse raw DEM data.

Alternatively, in one embodiment of the present disclosure, the extracting module 200 includes: an acquiring unit, a first calculating unit and a second calculating unit.

The acquiring unit is configured to read the raw DEM data and/or the inverse raw DEM data, and establish a rectangular plane coordinate system to determine a position of each grid.

The first calculating unit is configured to extract a square calculation region from the raw DEM data and/or the inverse raw DEM data, and extract a plurality of elevation data from any grid to obtain the elevation difference, based on the preset range.

The second calculating unit is configured to perform linear fitting on the plurality of elevation data, extract a plurality of contour features, and calculate a first derivative of a section curve according to the plurality of contour features.

Alternatively, in one embodiment of the present disclosure, the danger level value of each grid is calculated by a formula:

$${D}_{norm} = \frac{D - {D}_{min}}{{D}_{max} - {D}_{min}} \cdot 1000 ,$$

where Dₙₒᵣₘ is a dimensionless danger level, D is an original danger level value of the grid, Dₘᵢₙ is a minimum danger level value in all the grids, and Dₘₐₓ is a maximum danger level value in all the grids.

It should be noted that the foregoing explanations of the embodiments of the method for identifying the forest fire special dangerous terrain are also applicable to the apparatus for identifying the forest fire special dangerous terrain in the embodiments, and will not be repeated here.

According to the apparatus for identifying the forest fire special dangerous terrain in the embodiments of the present disclosure, the danger level value of the target area is calculated from the elevation difference and the first derivative of the contour line within a certain range of the target area, so as to identify the dangerous terrain of the valley between two mountains or the narrow ridge according to the danger level value. It is possible to achieve the purpose of identifying the dangerous terrain accurately, which improves the reliability and the accuracy of the dangerous terrain identification. Thus, the firefighters can effectively avoid the dangerous terrain, such that the safety coefficient is improved and the personal safety is ensured.

FIG. 12 is a schematic structural diagram of an electronic device provided according to embodiments of the present disclosure. The electronic device includes: a memory 1201, a processor 1202, and a computer program stored on the memory 1201 and executable on the processor 1202.

The processor 1202 executes the program to implement the method for identifying the forest fire special dangerous terrain provided in the above-mentioned embodiments.

Further, the electronic device also includes:
an communication interface 1203 configured for a communication between the memory 1201 and the processor 1202.

The memory 1201 is configured to store the computer program executable on the processor 1202.

The memory 1201 may include a high-speed random access memory (RAM), and may also include a non-volatile memory, such as at least one magnetic disk memory.

If the memory 1201, the processor 1202, and the communication interface 1203 are implemented independently, the communication interface 1203, the memory 1201, and the processor 1202 may be connected to each other through a bus and complete the communication between each other. The bus may be an industry standard architecture (ISA for short) bus, a peripheral component interconnect (PCI for short) bus, an extended industry standard architecture (EISA for short) bus, or the like. The bus can be divided into an address bus, a data bus, a control bus and so on. For ease of representation, only one thick line is used in FIG. 12, but it does not mean that there is only one bus or one type of bus.

Alternatively, in a specific implementation, if the memory 1201, the processor 1202, and the communication interface 1203 are integrated on one chip, then the memory 1201, the processor 1202, and the communication interface 1203 can communicate with each other through an internal interface.

The processor 1202 may be a central processing unit (CPU for short), or an application specific integrated circuit (ASIC for short), or configured to implement one or more integrated circuits in the embodiments of the present disclosure.

The embodiments also provide a computer-readable storage medium having stored therein a computer program, in which the program is executed by a processor to implement the above method for identifying the forest fire special dangerous terrain.

In the description of the present disclosure, reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the schematic representations of the above terms in this specification are not necessarily referring to the same embodiment or example. Furthermore, the particular features, structures, materials, or characteristics may be combined in any suitable manner in one or N embodiments or examples. Without a contradiction, the different embodiments or examples and the features of the different embodiments or examples described in this specification can be combined by those skilled in the art.

In addition, terms such as “first” and “second” are used herein for purposes of description and are not intended to indicate or imply relative importance or implicitly specifying the number of the indicated technical features. Furthermore, the feature defined with “first” and “second” may comprise at least one of these features explicitly or implicitly. In the description of the present disclosure, “N” means at least two, such as two, three, etc., unless specifically defined otherwise.

The flow chart or any process or method described herein in other manners may represent a module, segment, or portion of code that comprises one or N executable instructions to implement the custom logic function(s) or step(s) of a process. The scope of preferred embodiments of the present disclosure includes additional implementations in which functions may be performed out of the order shown or discussed, including in substantially simultaneous fashion or in reverse order depending on the functions involved, which should be understood by those skilled in the art to which the embodiments of the present disclosure belong.

The logic and/or step shown in the flow chart or described in other manners herein, for example, a sequenced list of executable instructions for realizing the logical function, may be specifically achieved in any computer readable medium to be used by an instruction execution system, device or equipment (such as a system based on computers, a system comprising processors or other systems capable of obtaining an instruction from the instruction execution system, device or equipment and executing the instruction), or to be used in combination with the instruction execution system, device or equipment. As to the specification, the “computer readable medium” may be any device including, storing, communicating, propagating or transferring programs to be used by or in combination with the instruction execution system, device or equipment. More specific examples (non-exhaustive list) of the computer readable medium comprise: an electronic connection (an electronic device) with one or N wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate mediums capable of printing programs thereon, this is because, for example, the paper or other mediums may be optically scanned and then edited, decrypted or processed with other appropriate methods when necessary to obtain the programs in an electronic manner, and then the programs may be stored in the computer memories.

It should be understood that each part of the present disclosure may be realized by hardware, software, firmware or their combination. In the above embodiments, N steps or methods may be realized by software or firmware stored in the memory and executed by the appropriate instruction execution system. For example, if it is realized by the hardware, likewise in another embodiment, the steps or methods may be realized by any one or a combination of the following techniques known in the art: a discrete logic circuit having a logic gate circuit for realizing a logic function of a data signal, an application-specific integrated circuit having an appropriate combinational logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when being run.

In addition, each functional unit of the embodiments of the present disclosure may be integrated in a processing module, or these units may be separate physical existence, or two or more units are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CDs, or the like. Although embodiments of the present disclosure have been shown and described, it would be appreciated that the above embodiments are exemplary and cannot be construed to limit the present disclosure, and changes, modifications, alternatives, and variations of the above embodiments can be made by those skilled in the art within the scope of the present disclosure.

1. A method for identifying a forest fire special dangerous terrain, comprising:
obtaining raw digital elevation model (DEM) data of a valley and inverse raw DEM data of a ridge in a target area;
extracting an elevation difference and a first derivative of a contour line within a preset range of the target area according to the raw DEM data and/or the inverse raw DEM data; and
calculating a danger level value of the target area based on the elevation difference and the first derivative of the contour line, wherein when the danger level value is greater than a preset threshold, it is determined that the target area is a dangerous terrain of a valley between two mountains or a narrow ridge;
wherein extracting the elevation difference and the first derivative of the contour line within the preset range of the target area according to the raw DEM data and/or the inverse raw DEM data comprises:
reading the raw DEM data and/or the inverse raw DEM data, and establishing a rectangular plane coordinate system to determine a position of each grid;
extracting a square calculation region from the raw DEM data and/or the inverse raw DEM data, and extracting a plurality of elevation data from any grid to obtain the elevation difference, based on the preset range; and
performing linear fitting on the plurality of elevation data, extracting a plurality of contour features, and calculating a first derivative of a section curve according to the plurality of contour features;
wherein the danger level value of each grid is calculated by a formula:
$${D}_{norm} = \frac{D - {D}_{min}}{{D}_{max} - {D}_{min}} \cdot {1000}_{,}$$
where Dₙₒᵣₘ is a dimensionless danger level, D is an original danger level value of the grid, Dₘᵢₙ is a minimum danger level value in all the grids, and Dₘₐₓ is a maximum danger level value in all the grids.

2. The method according to claim 1, wherein obtaining the raw DEM data of the valley and the inverse raw DEM data of the ridge in the target area further comprises:
performing searching based on a preset radius to obtain the raw DEM data; and/or
performing inverse terrain processing on the raw DEM data to obtain the inverse raw DEM data.

3.-8. (canceled)

9. An electronic device, comprising:
a memory,
a processor, and
a computer program stored on the memory and executable on the processor,
wherein the processor executes the computer program to:
obtain raw digital elevation model (DEM) data of a valley and inverse raw DEM data of a ridge in a target area;
extract an elevation difference and a first derivative of a contour line within a preset range of the target area according to the raw DEM data and/or the inverse raw DEM data; and
calculate a danger level value of the target area based on the elevation difference and the first derivative of the contour line, wherein when the danger level value is greater than a preset threshold, it is determined that the target area is a dangerous terrain of a valley between two mountains or a narrow ridge;
wherein the processor is further configured to:
read the raw DEM data and/or the inverse raw DEM data, and establish a rectangular plane coordinate system to determine a position of each grid;
extract a square calculation region from the raw DEM data and/or the inverse raw DEM data, and extract a plurality of elevation data from any grid to obtain the elevation difference, based on the preset range; and
perform linear fitting on the plurality of elevation data, extract a plurality of contour features, and calculate a first derivative of a section curve according to the plurality of contour features;
wherein the danger level value of each grid is calculated by a formula:
$${D}_{norm} = \frac{D - {D}_{min}}{{D}_{max} - {D}_{min}} \cdot 1000 ,$$
where Dₙₒᵣₘ is a dimensionless danger level, D is an original danger level value of the grid, Dₘᵢₙ is a minimum danger level value in all the grids, and Dₘₐₓ is a maximum danger level value in all the grids.

10. A non-transitory computer-readable storage medium having stored therein a computer program, wherein the computer program is executed by a processor to:
obtain raw digital elevation model (DEM) data of a valley and inverse raw DEM data of a ridge in a target area;
extract an elevation difference and a first derivative of a contour line within a preset range of the target area according to the raw DEM data and/or the inverse raw DEM data; and
calculate a danger level value of the target area based on the elevation difference and the first derivative of the contour line, wherein when the danger level value is greater than a preset threshold, it is determined that the target area is a dangerous terrain of a valley between two mountains or a narrow ridge;
wherein the processor is further configured to:
read the raw DEM data and/or the inverse raw DEM data, and establish a rectangular plane coordinate system to determine a position of each grid;
extract a square calculation region from the raw DEM data and/or the inverse raw DEM data, and extract a plurality of elevation data from any grid to obtain the elevation difference, based on the preset range; and
perform linear fitting on the plurality of elevation data, extract a plurality of contour features, and calculate a first derivative of a section curve according to the plurality of contour features;
wherein the danger level value of each grid is calculated by a formula:
$${D}_{norm} = \frac{D - {D}_{min}}{{D}_{max} - {D}_{min}} \cdot {1000}_{,}$$
where Dₙₒᵣₘ is a dimensionless danger level, D is an original danger level value of the grid, Dₘᵢₙ is a minimum danger level value in all the grids, and Dₘₐₓ is a maximum danger level value in all the grids.

11. The electronic device according to claim 9, wherein the processor is further configured to:
perform searching based on a preset radius to obtain the raw DEM data; and/or
perform inverse terrain processing on the raw DEM data to obtain the inverse raw DEM data.

12. The non-transitory computer-readable storage medium according to claim 10, wherein the processor is further configured to:
perform searching based on a preset radius to obtain the raw DEM data; and/or
perform inverse terrain processing on the raw DEM data to obtain the inverse raw DEM data.
